(19) United States
(12) Patent Application Publication
(10) Pub. No.: US 2026/0332617 A1
(43) Pub. Date: Oct. 22, 2026

(54) CLASSIFYING DEVICE, CLASSIFYING METHOD, AND CLASSIFYING PROGRAM

(71) Applicant: NTT, Inc., Tokyo (JP)

(72) Inventors: Hiroki NAKANO, Musashino-shi, Tokyo (JP); Daiki CHIBA, Musashino-shi, Tokyo (JP); Takashi KOIDE, Musashino-shi, Tokyo (JP); Naoki FUKUSHI, Musashino-shi, Tokyo (JP)

(73) Assignee: NTT, Inc., Tokyo (JP)

(21) Appl. No.: 19/113,929

(22) PCT Filed: Oct. 27, 2022
(86) PCT No.: PCT/JP2022/040260

§ 371 Date: Mar. 21, 2025

(51) Int. Cl. H04L 9/40; G06F 18/241

(52) U.S. Cl. CPC H04L 63/1425; G06F 18/241; H04L 63/1416

(57) ABSTRACT

A classification apparatus includes a memory, and processing circuitry configured to extract feature values of text and an image included in a post related to a security threat of a Social Networking Service (SNS) from the post, perform learning using the feature values for teaching data to which a correct answer label indicating whether each post is a post related to the security threat is attached to thereby learn a machine learning model for classifying whether an input post is a post related to the security threat, classify whether an input post is a post related to the security threat by using the learned machine learning model, and output a result of classification.

### TECHNICAL FIELD

The present invention relates to a classification apparatus, a classification method, and a classification program for classifying posts related to security threat information.

### BACKGROUND ART

On social platforms, in addition to security experts, well-intentioned general users often share images (for example, screenshots) of suspicious phishing attack cases they have observed themselves as calling warning. When this information can be accurately collected, analyzed, and extracted as soon as possible, it is useful for countermeasures against phishing attacks.

Security blogs, security reports, social platforms and the like are available as objects for extracting security threat information such as phishing attacks.

For example, as in NPL 3 and NPL 4, natural language processing technology is applied to a blog or a report in which threat information analyzed by a security specialist is collected to extract formatted data, and thus the data can be mechanically utilized.

Further, in NPL 5, Twitter (registered trademark), Facebook (registered trademark), news sites, security blogs, security forums, and the like are compared and evaluated as threat information collecting targets, and it has been reported that Twitter is the best in terms of both the quantity and quality of information that can be collected.

NPL 6, NPL 7, and NPL 8 propose technology for extracting URLs, domain names, hash values, IP addresses, vulnerability information, and the like related to threats from Tweets of users by focusing on specific users and keywords of Twitter. According to the technology, it has been reported that a large amount of useful threat information can be obtained.

### CITATION LIST

### Non Patent Literature

[NPL 1] Ongoing Phishing Attacks—Unique URL, Average of Approximately 270 per day, Security NEXT, [online], [retrieved Oct. 13, 2022], Internet <URL:https://www.security-next.com/134607>
[NPL 2] 2022/02 Phishing report status, [online], Council of Anti-Phishing Japan, [retrieved Oct. 13, 2022], Internet <URL:https://www.antiphishing.jp/report/monthly/202202.html>
[NPL 3] Zhu, Ziyun and Dumitras, Tudor, “ChainSmith: Automatically Learning the Semantics of Malicious Campaigns by Mining Threat Intelligence Reports”, 2018 IEEE European Symposium on Security and Privacy
[NPL 4] Satvat, Kiavash and Gjomemo, Rigel and Venkatakrishnan, V. N., “EXTRACTOR: Extracting Attack Behavior from Threat Reports”, IEEE EuroS&P 2021.
[NPL 5] Shin, Hyejin and Shim, WooChul and Moon, Jiin and Seo, Jae Woo and Lee, Sol and Hwang, Yong Ho, “Cybersecurity Event Detection with New and Re-emerging Words,” ASIA CCS 2020.
[NPL 6] Alves, Fernando and Andongabo, Ambrose and Gashi, Ilir and Ferreira, Pedro M. and Bessani, Alysson, “Follow the Blue Bird: A Study on threat data published on Twitter”, ESORICS 2020.
[NPL 7] Shin, Hyejin and Shim, WooChul and Kim, Saebom and Lee, Sol and Kang, Yong Goo and Hwang, Yong Ho, “#Twiti: Social Listening for Threat Intelligence”, WWW 2021.
[NPL 8] Roy, Sayak Saha and Karanjit, Unique and Nilizadeh, Shirin, “Evaluating the Effectiveness of Phishing Reports on Twitter”, eCrime 2021.

### SUMMARY OF INVENTION

### Technical Problem

However, the above-described related art has the following problems.
(1) A Tweet, which is an information collecting target, is limited

In the related art, an information collecting target is limited to a specific user account, and thus information on phishing attack reports made by various users cannot be collected. Further, in the related art, limited keywords such as “#phishing” and “#calling warning” are collecting targets, and thus only Tweets with a limited range can be collected.
(2) An information extraction target is only a sentence in a fixed form included in a Tweet

Although phishing attack reports through a Tweet include images such as screen shots, only sentences in a Tweet are used as information extraction targets in the related art. For this reason, information included in images cannot be extracted in the related art. Further, since users post information in various forms, only limited information can be extracted in the related art specialized in a fixed form.

As a result, the related art has a problem that useful security threat information cannot be extracted. Consequently, an object of the present invention is to solve the above-described problems and extract useful security threat information.

### Solution to Problem

In order to solve the above-described problem, the present invention provides a feature value extraction unit configured to extract feature values of text and an image included in a post related to a security threat of a Social Networking Service (SNS) from the post, a learning unit configured to perform learning using the feature values for teaching data to which a correct answer label indicating whether each post is a post related to the security threat is attached to thereby learn a machine learning model for classifying whether an input post is a post related to the security threat, a classification unit configured to classify whether an input post is a post related to the security threat by using the learned machine learning model, and an output processing unit configured to output a result of classification.

### Advantageous Effects of Invention

According to the present invention, it is possible to extract useful security threat information.

### BRIEF DESCRIPTION OF DRAWINGS

FIG. 1 is a diagram showing a configuration example of a system.

FIG. 2A is a diagram showing a configuration example of a collection device.

FIG. 2B is a flowchart showing an example of a processing procedure executed by the collection device.

FIG. 3 is a diagram showing a specific example of a processing procedure executed by the collection device.

FIG. 4 is a diagram showing an example of Security Keywords.

FIG. 5 is a diagram showing an example of generation of Co-occurrence Keywords.

FIG. 6 is a diagram showing an example of a Tweet which is a data collecting target.

FIG. 7 is a diagram showing processing for extracting an URL and a domain name from text and an image of a Tweet.

FIG. 8A is a diagram showing a configuration example of a classification apparatus.

FIG. 8B is a flowchart showing an example of a processing procedure executed by the classification apparatus.

FIG. 9 is a diagram showing a specific example of the processing procedure executed by the classification apparatus.

FIG. 10 is a diagram showing an example of feature values generated by a Tweet.

FIG. 11 is a diagram showing an example of Account Features of a Tweet.

FIG. 12 is a diagram showing an example of Content Features of a Tweet.

FIG. 13 is a diagram showing an example of URL Features of a Tweet.

FIG. 14 is a diagram showing an example of OCR Features of a Tweet.

FIG. 15 is a diagram showing an example of Visual Features of a Tweet.

FIG. 16 is a diagram showing an example of Context Features of a Tweet.

FIG. 17 shows an example of feature values selected by a selection unit in FIG. 8A.

FIG. 18 is a diagram showing evaluation results of the accuracy of evaluation of the system.

FIG. 19 is a diagram showing phishing attack reports extracted by the system during a predetermined period and the number of URLs related to the phishing attacks.

FIG. 20 is a diagram showing results of comparison between the system and OpenPhish.

FIG. 21 is a diagram showing results of comparison between the system and PhishTank.

FIG. 22 is a diagram showing results of reports of the number of times users shared reports and the number of phishing URLS.

FIG. 23 is a diagram showing the effect of dynamically selecting a keyword.

FIG. 24 is a diagram showing a computer that executes a program.

### DESCRIPTION OF EMBODIMENTS

Hereinafter, modes (embodiments) for carrying out the present invention will be described with reference to the accompanying drawings. The present invention is not limited to the present embodiment.

### Overview

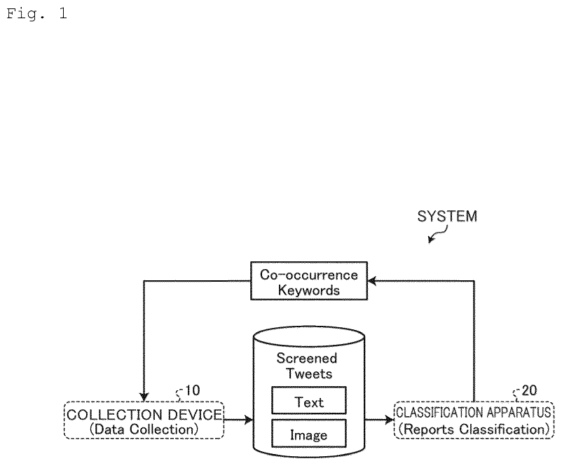

First, an overview of a system including a collection device and a classification apparatus according to the present embodiment will be described with reference to FIG. 1.

Social Networking Service (SNS) posts handled by the system will be described using a case where they are Twitter posts (Tweet), but the present invention is not limited thereto. The SNS posts may be posts in Japanese or posts in English.

Further, in the present embodiment, the system will be described using a case where posts related to phishing attack reports are collected from SNS posts as an example, but posts related to reports of security threats other than phishing attacks may be collected.

For example, the system extracts a Tweet on a phishing attack report from Tweets of users at an early stage and with high accuracy. For example, the system is configured to include a collection device 10 and a classification apparatus 20. The collection device 10 and the classification apparatus 20 may be communicatively connected to each other via a network such as the Internet, or may be provided in the same apparatus.
(1) Collection device 10: Tweet which is likely to be phishing attack report is widely collected. For example, the collection device 10 extracts keywords co-occurring (Co-occurrence Keywords) with a phishing attack report. Then, the collection device 10 widely collects Tweets (Screened Tweets in FIG. 1) which are likely to be phishing attack reports by using keywords (Security Keywords) related to security threats and the above-described Co-occurrence Keywords.
(2) Classification apparatus 20: Tweets on phishing attack reports are classified from Tweets collected by collection device 10. For example, the classification apparatus 20 extracts features of text and images of Tweets on phishing attack reports by machine learning, and classifies whether each Tweet is a Tweet on a phishing attack report or any of other Tweets by using the extracted features.

After Tweets are classified by the classification apparatus 20, the collection device 10 may extract Co-occurrence Keywords from a Tweet group classified as Tweets on phishing attack reports. Then, the collection device 10 may collect Tweets which are likely to be phishing attack reports by using the extracted Co-occurrence Keywords. In this manner, the system can dynamically expand/contract keywords for collecting Tweets which are likely to be phishing attack reports, and can collect Tweets to be collected at an appropriate timing.

According to such a system, Tweets on phishing attack reports can be collected not only from security experts but also from well-intentioned general users. Since the system collects Tweets with a large number of keywords, phishing attack reports can be analyzed on a large scale.

In addition, the system can accurately extract a phishing attack report from the collected large-scale Tweets. Furthermore, the system extracts information on a phishing attack from both text and an image included in a Tweet, and thus useful information which cannot be obtained only by analyzing text of a Tweet can be extracted.

The present system provides the following effects on a countermeasure against a phishing attack.
(1) Threat information can be collected from a wide range beyond a limited monitoring target of the related art, and threat information can be provided from a new viewpoint.
(2) In particular, threat information which can be utilized as a countermeasure against a phishing attack targeting Japanese which has been insufficient up to now can be rapidly provided.
(3) Applying data obtained by the present system to a filtering rule of a communication carrier or the like leads to a reduction in the number of victims such as those of phishing attacks.

### Collection Device

### Configuration Example

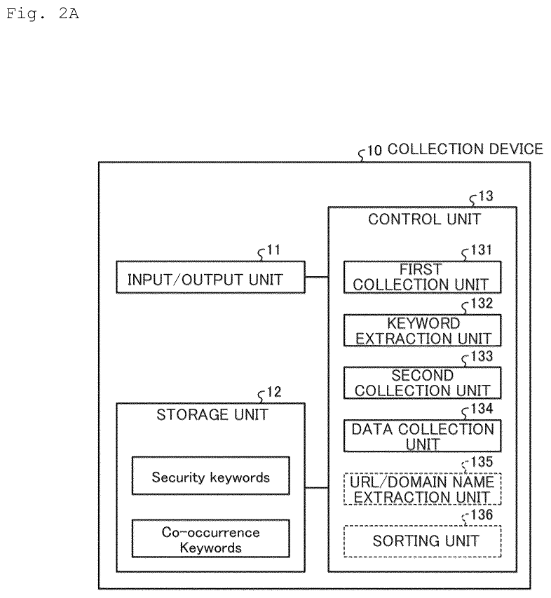

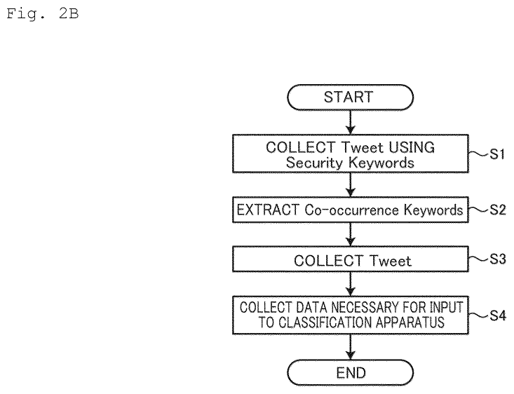

Next, the collection device 10 will be described in detail. First, a configuration example of the collection device 10 will be described with reference to FIG. 2A. The collection device 10 includes, for example, an input/output unit 11, a storage unit 12, and a control unit 13.

The input/output unit 11 is an interface configured to control the input and output of various data. The input/output unit 11 receives, for example, an input of a Tweet collected from a Twitter. In addition, the input/output unit 11 outputs, for example, Tweets (Screened Tweets in FIG. 1) which are likely to be phishing attack reports extracted by the control unit 13.

The storage unit 12 stores data, programs, and the like referred to by the control unit 13 when executing various types of processing. The storage unit 12 is implemented using a semiconductor memory element such as a Random Access Memory (RAM) or a Flash Memory, or a storage device such as a hard disk or an optical disc. The storage unit 12 stores, for example, Security Keywords, Co-occurrence Keywords, and the like extracted by the control unit 13.

The control unit 13 controls the entire collection device 10. The function of the control unit 13 is implemented by, for example, a Central Processing Unit (CPU) executing a program stored in the storage unit 12.

The control unit 13 includes, for example, a first collection unit 131, a keyword extraction unit 132, a second collection unit 133, and a data collection unit 134. An URL/domain name extraction unit 135 and a sorting unit 136, which are indicated by dashed lines, may or may not be provided, and a case where they are provided will be described below.

The first collection unit 131 collects Tweets on phishing attack reports from Tweets of users by using Security Keywords which are keywords related to security threats.

The keyword extraction unit 132 extracts Co-occurrence Keywords which are co-occurring keywords exceeding a predetermined frequency from Tweets on phishing attack reports collected by the first collection unit 131. The Co-occurrence Keywords may be extracted from Tweets classified as Tweets on phishing attack reports by the classification apparatus 20.

The second collection unit 133 collects Tweets which are likely to be phishing attack reports from Tweets of users by using Co-occurrence Keywords. For example, the second collection unit 133 collects, from the Tweets of the users, Tweets including Security Keywords and Co-occurrence Keywords in text of the Tweets or images associated with the Tweets. The collected Tweets are stored in, for example, the storage unit 12.

The data collection unit 134 collects data necessary for an input to the classification apparatus 20. For example, the data collection unit 134 collects the following data from the Tweets collected by the second collection unit 133. (1) Character strings of Tweets (for example, a hashtag, the number of characters, and the like), (2) meta information associated with a Tweet (for example, application information, the presence or absence of defanging, and the like), (3) information on an account of a Tweet (for example, the number of followers of the account, an account registration period, and the like), (4) an image included in a Tweet (for example, a maximum of four images associated with the Tweet, and the like). The collected data is stored in, for example, the storage unit 12.

### Example of Processing Procedure

Next, an example of a processing procedure executed by the collection device 10 will be described with reference to FIG. 2B. First, the first collection unit 131 of the collection device 10 collects Tweets on phishing attack reports using, for example, Security Keywords (S1: Collection of Tweets using Security Keywords). Then, the keyword extraction unit 132 extracts Co-occurrence Keywords which are co-occurring keywords exceeding a predetermined frequency from the Tweets on the phishing attack reports collected in S1 (S2: Extraction of Co-occurrence Keywords).

After S2, the second collection unit 133 collects Tweets which are likely to be phishing attack reports from Tweets of users by using the Security Keywords and the Co-occurrence Keywords (S3). Thereafter, the data collection unit 134 collects data necessary for an input to the classification apparatus 20 from the Tweets collected in S3 (S4).

The collection device 10 executes the above-described processing to collect Tweets which are likely to be phishing attack reports.

The collection device 10 may include the URL/domain name extraction unit 135 and the sorting unit 136 shown in FIG. 2A.

The URL/domain name extraction unit 135 extracts an URL and a domain name from text and images of the Tweets collected by the second collection unit 133. The sorting unit 136 sorts a Tweet which is highly likely to be a phishing attack report from the Tweets collected by the second collection unit 133 based on the URL or the domain name extracted by the URL/domain name extraction unit 135.

For example, when an URL or a domain included in the Tweet collected by the second collection unit 133 is not included in a list of URLs or domain names of legitimate websites, the sorting unit 136 sorts the Tweet as a Tweet which is highly likely to be a phishing attack report. In addition, when a use period of the domain name of the URL included in the Tweet is less than a predetermined period, the sorting unit 136 sorts the Tweet which is highly likely to be a phishing attack report. For example, the sorting unit 136 sorts a domain name whose elapsed days after registration in WHOIS is less than a predetermined number of days as a Tweet which is highly likely to be a phishing attack report.

Thereafter, the data collection unit 134 collects data (for example, a character string of a Tweet, and the like) which is necessary for an input to the classification apparatus 20 from the Tweet sorted by the sorting unit 136.

In this manner, the collection device 10 can collect a Tweet which is more likely to be phishing attack reports from the collected Tweets, and data thereof.

### Specific Example of Processing Procedure

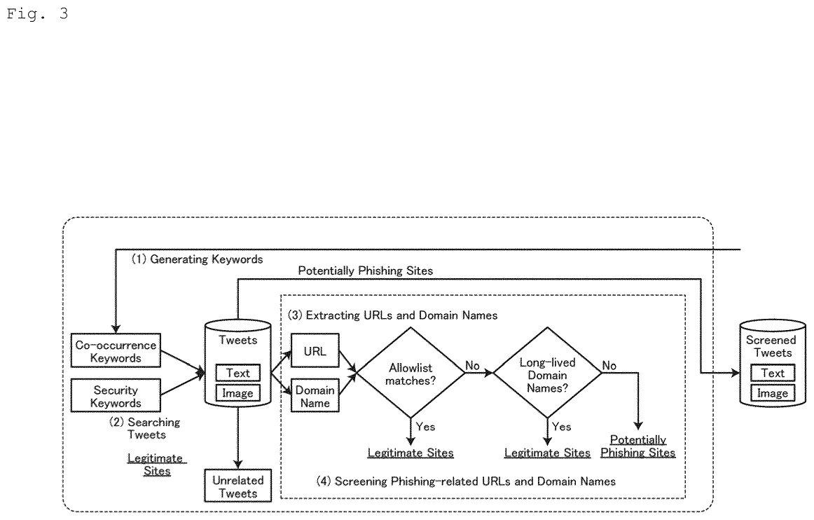

Next, a specific example of a processing procedure executed by the collection device 10 will be described with reference to FIG. 3. A case where the collection device 10 is provided with the URL/domain name extraction unit 135 and the sorting unit 136 will be described as an example.

### (1) Generating Keywords

The collection device 10 generates two types of keywords (Security Keywords and Co-occurrence Keywords) for retrieving a Tweet including a phishing attack report.

### (1-1) Security Keywords

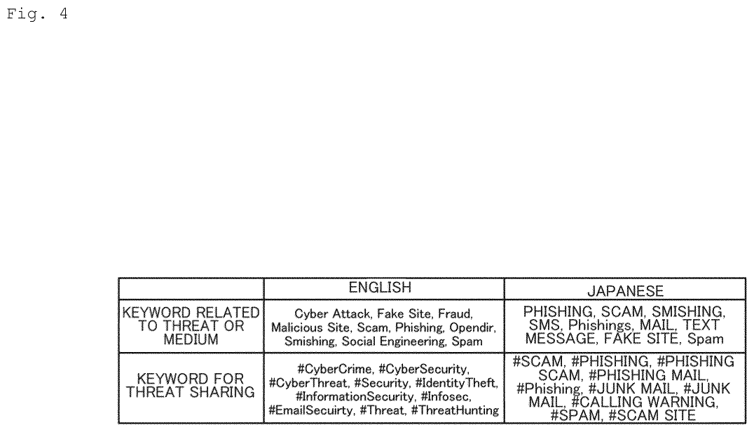

First, Security Keywords will be described. For example, the collection device 10 generates, as Security Keywords, keywords related to a security threat and a medium to which the security threat is diffused, such as “SMS” or “fake site”, and keywords for sharing security threat information such as “#phishing” and “#scam” (see FIG. 4). As the Security Keywords, existing keywords related to a security threat may be used.

### (1-2) Security Keywords

Next, Co-occurrence Keywords will be described. For example, the collection device 10 extracts keywords (Co-occurrence Keywords) co-occurring with only phishing attack reports collected using Security Keywords as keys at a frequency exceeding a predetermined value.

For example, the first collection unit 131 of the collection device 10 collects Tweets on phishing attack reports from Tweets of users by using Security Keywords. Thereafter, the keyword extraction unit 132 extracts Co-occurrence Keywords from the collected Tweets. For example, the keyword extraction unit 132 newly extracts Co-occurrence Keywords from Tweets collected in a predetermined period for each predetermined period.

For example, the keyword extraction unit 132 extracts proper nouns from character strings of Tweets for a predetermined period, and calculates Pointwise Mutual Information (PMI) in accordance with the following Formula (1). In Formula (1), X and Y are proper nouns included in a Tweet.

PMI(X,Y)=Log(P(X,Y)/P(X)P(Y)) Formula (1)

Next, the keyword extraction unit 132 calculates SoA in accordance with Formula (2). In Formula (2), W is a proper noun included in a Tweet, and L is a label (security threat information or the like).

SoA(W,L)=PMI(W,L)−PMI(W,¬L) Formula (2)

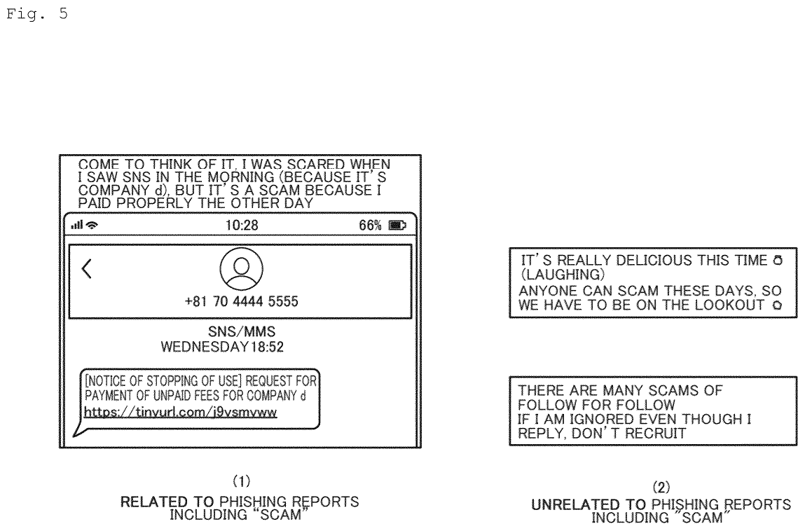

Then, the keyword extraction unit 132 extracts a proper noun in which SoA exceeds a predetermined threshold value. For example, a Tweet including a Security Keyword “scam” includes a Tweet related to a phishing report shown in (1) of FIG. 5 and a Tweet not related to a phishing report shown in (2) of FIG. 5. The keyword extraction unit 132 extracts “d company” and “SMS” which are proper nouns (SoA exceeds a predetermined threshold value) which frequently appear only in a Tweet ((1) ) related to phishing reports including “scam” among them as Co-occurrence Keywords.

### (2) Searching Tweets

Next, the collection device 10 collects data necessary for an input to the classification apparatus 20 from Twitter. For example, the second collection unit 133 collects Tweets which are likely to be phishing attack reports from Tweets of users by using the Co-occurrence Keywords extracted by the keyword extraction unit 132. Thereby, the second collection unit 133 can collect Tweets including URLs and domains of Potentially Phishing Sites, for example, as shown in FIG. 3.

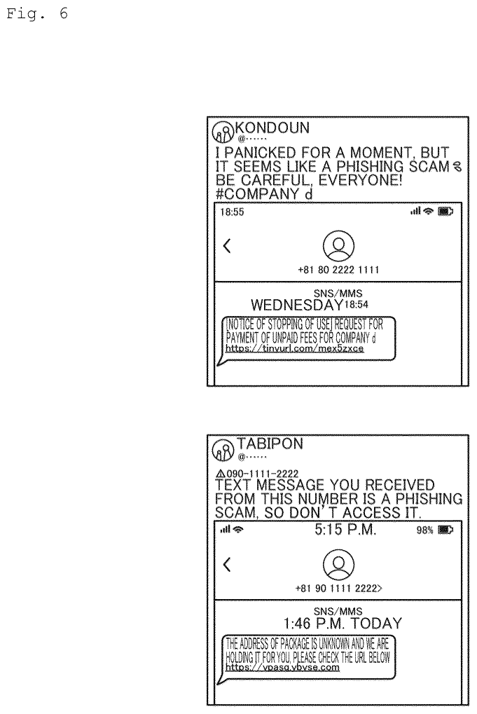

That is, the second collection unit 133 can collect Tweets (Screened Tweets) excluding Tweets (Unrelated Tweets) related to Legitimate Sites among the Tweets of the users. The data collection unit 134 collects the following data regarding the Tweets (see FIG. 6) collected by the second collection unit 133.

Character strings of Tweets (for example, a hashtag, the number of characters, and the like), meta information associated with a Tweet (for example, application information, the presence or absence of a defang, and the like), information on an account of a Tweet (for example, the number of followers an account registration period, and the like), and an image included in a Tweet (for example, a maximum of four images associated with the Tweet, and the like).

### (3) Extracting URLs and Domain Names

Next, the URL/domain name extraction unit 135 of the collection device 10 extracts URLs and domain names from text and images of Tweets (Screened Tweets) collected by the second collection unit 133.

For example, the URL/domain name extraction unit 135 extracts character strings by applying optical character recognition to images of Tweets. The URL/domain name extraction unit 135 returns a character string of a Tweet to its original character string when the character string of the Tweet includes a defang (for example, https→ttps). Then, the URL/domain name extraction unit 135 extracts an URL and a domain name by a normal expression from a character string of text and an image of a Tweet. Thereafter, the URL/domain name extraction unit 135 confirms whether there may be an extracted domain name by using a Public Suffix List (see Literature 1) or the like.
Literature 1:“Public Suffix List”, https://publicsuffix.org/

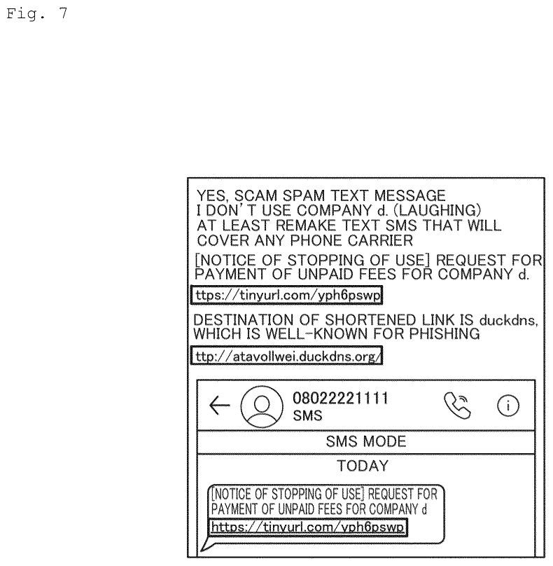

Then, when URL/domain name extraction unit 135 confirms that there is an extracted domain name, the URL/domain name extraction unit 135 extracts the domain name and an URL including the domain name. For example, the URL/domain name extraction unit 135 extracts the following URL and domain name from a Tweet shown in FIG. 7.
URL:https://tinyurl.com/yph6pswp, https://atavollwei.duckdns.org
Domain name: tinyurl.com, atavollwei.duckdns.org
(4) Screening Phishing-related URLs and Domain Names Next, the sorting unit 136 screens URLs and domain names related to phishing from the URLs and the domain names extracted by the URL/domain name extraction unit 135.

For example, when the extracted URLs and domain names do not match an Allowlist (for example, a list of URLs or domain names of legitimate websites) and are not Long-lived Domain Names (for example, domain names whose elapsed days after registration in WHOIS is less than a predetermined number of days), the sorting unit 136 determines that the extracted URLs and domain names are Potentially Phishing Sites. Then, the sorting unit 136 sorts a Tweet including the URLs or the domain names determined to be the Potentially Phishing Sites as a Tweet which is highly likely to be a phishing attack report.

On the other hand, when the extracted URLs and domain names match the Allowlist or Long-lived Domain Names, the sorting unit 136 sets the URLs and the domain names to be Legitimate Sites.

For example, when the extracted domain name corresponds to a domain name of a predefined URL shortening service, the sorting unit 136 passes the domain name. When the extracted domain name matches a Tranco List (see Literature 2), the sorting unit 136 excludes the domain name as a domain name which is not related to a phishing attack.
Literature 2: “A research-oriented top sites ranking hardened against manipulation—Tranco”, https://tranco-list.eu/

In addition, the sorting unit 136 inquires the extracted domain name of WHOIS, and when information cannot be acquired, the sorting unit 136 passes the domain name. Further, the sorting unit 136 excludes the domain name when 365 days or more have elapsed after registration based on the WHOIS information, and passes the domain name when 365 days have not elapsed after the registration. Then, the sorting unit 136 sorts, for example, a Tweet having at least one type of URL or domain name passed in the above-described processing as a Tweet which is highly likely to be a phishing attack report.

In this manner, the collection device 10 can extract a Tweet which is highly likely to be a phishing attack report from Tweets of users.

### Classification Apparatus

### Configuration Example

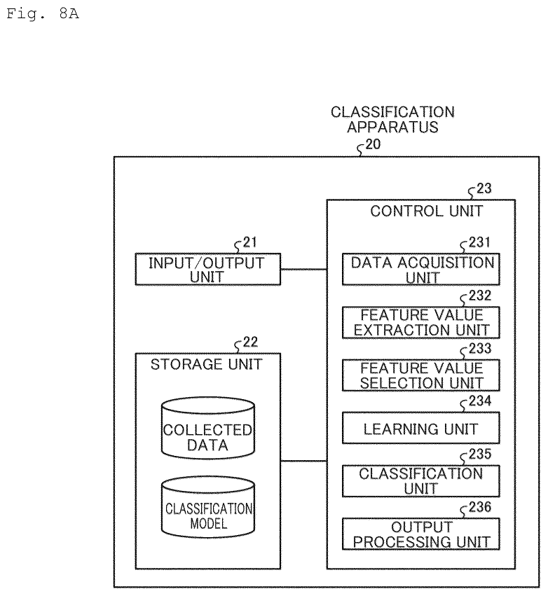

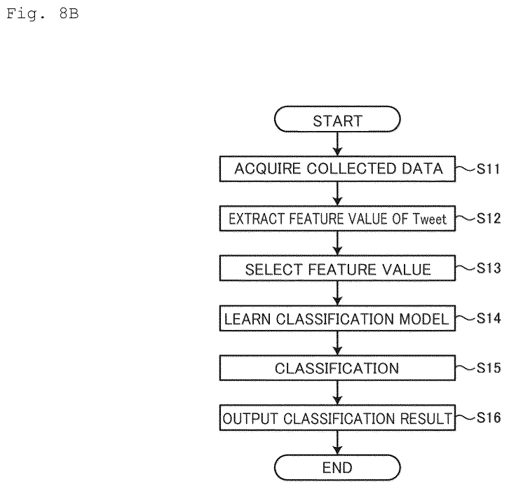

Next, the classification apparatus 20 will be described in detail. First, a configuration example of the classification apparatus 20 will be described with reference to FIG. 8A. The classification apparatus 20 includes, for example, an input/output unit 21, a storage unit 22, and a control unit 23.

The input/output unit 21 is an interface configured to control the input and output of various data. The input/output unit 21 receives, for example, inputs of Tweets which are likely to be phishing attack reports collected by the collection device 10 and data thereof. In addition, the input/output unit 21 outputs classification results of the control unit 23.

The storage unit 22 stores data, programs, and the like referred to by the control unit 23 when executing various types of processing. The storage unit 22 is implemented using a semiconductor memory element such as a RAM or a flash memory, or a storage device such as a hard disk or an optical disc. For example, the storage unit 22 stores Tweets which are highly likely to be phishing attack reports and data thereof (collected data) which are received by the input/output unit 21. In addition, the storage unit 22 stores parameters of a classification model, and the like after learning the classification model by the control unit 23.

The control unit 23 controls the entire classification apparatus 20. The function of the control unit 23 is implemented by, for example, a CPU executing a program stored in the storage unit 22.

The control unit 23 includes, for example, a data acquisition unit 231, a feature value extraction unit 232, a feature value selection unit 233, a learning unit 234, a classification unit 235, and an output processing unit 236.

The data acquisition unit 231 acquires a Tweet which is highly likely to be a phishing attack report and data thereof from the collection device 10.

The feature value extraction unit 232 extracts feature values from the Tweet and the data thereof which are acquired by the data acquisition unit 231. For example, the feature value extraction unit 232 extracts feature values of text and images of the Tweet acquired by the data acquisition unit 231.

For example, the feature value extraction unit 232 extracts, from the Tweet acquired by the data acquisition unit 231, a feature value of an account of the Tweet, a feature value of a content of the Tweet, a feature value of an URL or a domain name included in the Tweet, a feature value of a character string obtained by optical character recognition of an image included in the post, a feature value of an image included in the Tweet, a feature value of a context of text included in the Tweet, and the like. Details of the feature values of the Tweet which are extracted by the feature value extraction unit 232 will be described later using a specific example.

The feature value selection unit 233 selects a feature value effective for classification of whether it is a Tweet related to a phishing attack report from the feature values extracted by the feature value extraction unit 232. As a method of selecting a feature value, for example, Boruta-SHAP (see Literature 3 and 4) is used.
Literature 3: Kursa, Miron B. and Rudnicki, Witold R., “Feature Selection with the Boruta Package,” Journal of Statistical Software 2010.
Literature 4:“BorutaShap: A wrapper feature selection method which combines the Boruta feature selection algorithm with Shapley values,”
https://zenodo.org/badge/latestdoi/255354538

For example, the feature value selection unit 233 selects a feature value effective for classification of whether it is a Tweet related to a phishing attack report from among the feature values extracted by the feature value extraction unit 232 in accordance with the following procedure.
(1) First, the feature value selection unit 233 generates fake feature values including random values in addition to feature values to be selected.
(2) Next, the feature value selection unit 233 classifies the feature values to be selected and the fake feature values in accordance with a decision tree-based algorithm, and calculates a variable importance degree of each feature value.
(3) Next, when the variable importance degree of the feature value to be selected which is calculated in (2) is larger than a variable importance degree of the fake feature value, the feature value selection unit 233 counts it.
(4) The feature value selection unit 233 repeats the processing of (1) to (3) a plurality of times, and selects a feature value which is statistically determined to be significant as a feature value which is effective for classification.

The learning unit 234 learns a machine learning model (classification model) for classifying whether an input Tweet is a Tweet on a phishing attack report by supervised learning using the feature value selected by the feature value selection unit 233. For example, the learning unit 234 learns the classification model by supervised learning using the feature value selected by the feature value selection unit 233 with respect to teaching data related to a phishing attack (data to which a correct answer label indicating whether each Tweet is a phishing attack is attached).

The classification unit 235 classifies whether an input Tweet is a Tweet on a phishing attack report by using the classification model learned by the learning unit 234. The output processing unit 236 outputs results of classification of Tweets which is performed by the classification unit 235.

### Example of Processing Procedure

Next, an example of a processing procedure executed by the classification apparatus 20 will be described with reference to FIG. 8B. First, the data acquisition unit 231 of the classification apparatus 20 acquires a Tweet which is highly likely to be a phishing attack report collected by the collection device 10 and data thereof (S11: Acquisition of collected data). Thereafter, the feature value extraction unit 232 extracts feature values from the Tweet acquired by the data acquisition unit 231 and the data thereof (S12: Extraction of feature value of Tweet).

After S12, the feature value selection unit 233 selects a feature value effective for classification of whether it is a Tweet related to a phishing attack report from among the feature values extracted in S12 (S13). Then, the learning unit 234 learns a classification model for classifying whether an input Tweet is a Tweet on a phishing attack report by using the feature value selected in S13 with respect to teaching data related to a phishing attack (S14).

After S14, the classification unit 235 classifies whether an input Tweet is a Tweet on a phishing attack report by using the classification model learned in S14 (S15). Then, the output processing unit 236 outputs results of the classification in S16 (S16).

### Specific Example of Processing Procedure

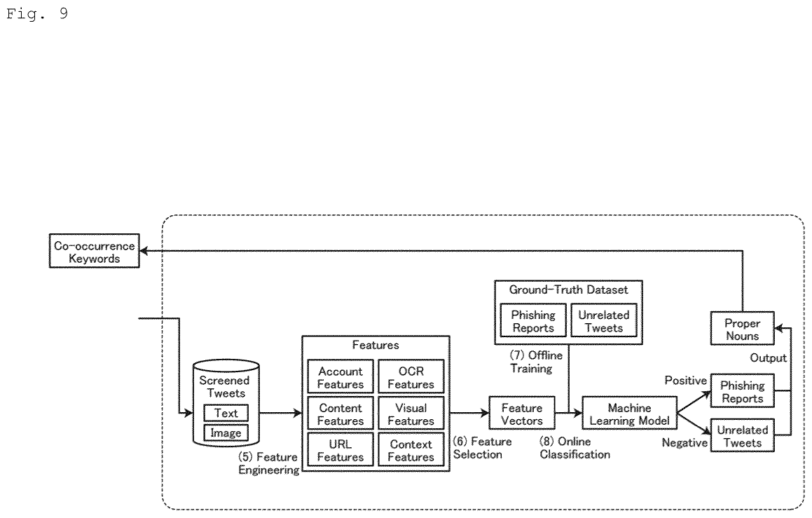

Next, a specific example of a processing procedure executed by the classification apparatus 20 will be described with reference to FIG. 9.

### (5) Feature Engineering

First, the data acquisition unit 231 of the classification apparatus 20 acquires Tweets (Screened Tweets) collected by the collection device 10 and data thereof. The feature value extraction unit 232 extracts feature values from the Tweets and the data thereof which are acquired by the data acquisition unit 231.

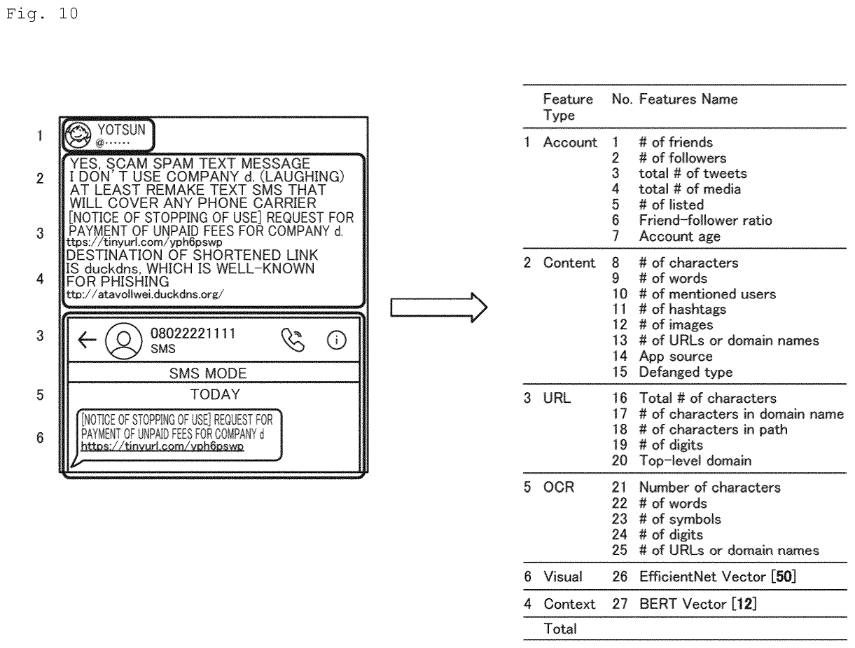

For example, as shown in FIG. 10, the feature value extraction unit 232 generates feature values of six types and a total of 27 items, that is, an Account Feature (1) from an account of a Tweet, a Content Feature (2) from information based on a Tweet, an URL Feature (3) from an extracted URL, an OCR Feature (5) from a character string extracted by OCR, a Visual Feature (6) from the appearance of an image, and a Context Feature (4) from a context of a Tweet. Hereinafter, the feature values will be described in detail.

### (5-1) Account Feature

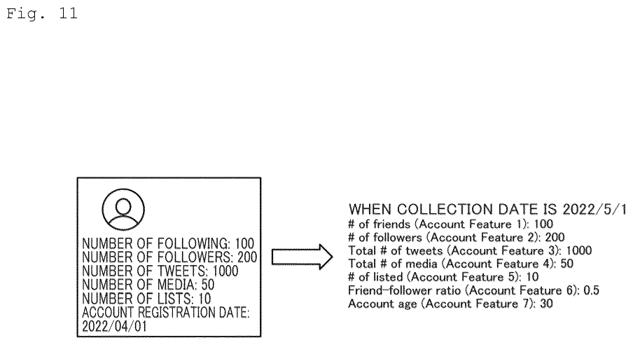

In order to capture features of a user of a Twitter, the feature value extraction unit 232 generates Account Features for each Tweet from information on an account of a user (for example, the number of followed persons, the number of followers, the number of Tweets, the number of media, the number of lists, an account registration date, and the like), for example, as shown in FIG. 11.

### (5-2) Content Feature

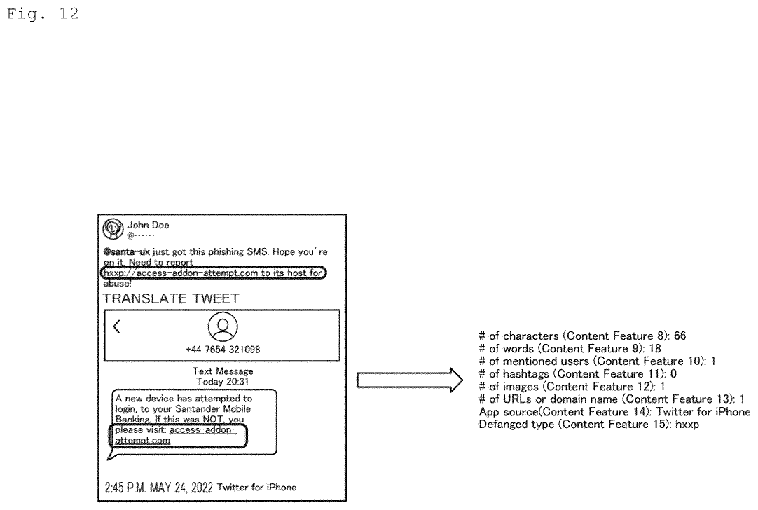

In order to capture features of a content frequently appearing in a Tweet on a phishing attack report, the feature value extraction unit 232 generates Content Features for each Tweet from information associated with the Tweet itself (for example, character strings, mentioned users, hashtags, images, URLs or domain names, applications used for Tweets, a defanged type, and the like), for example, as shown in FIG. 12.

### (5-3) URL Feature

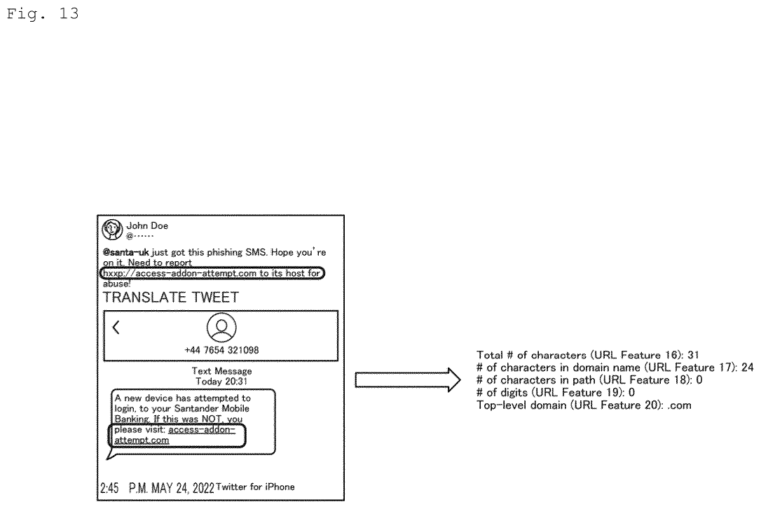

In order to capture features related to abuse of a sub-domain specific to a phishing URL and abuse of a specific Top-level domain, the feature value extraction unit 232 generates URL Features for each Tweet from URLs (or domain names) extracted from both a character string and an image of a Tweet, for example, as shown in FIG. 13. The URL Features include, for example, a character string of an URL, a domain name, a path, digits included in the URL, a Top-level domain, and the like.

### (5-4) OCR Feature

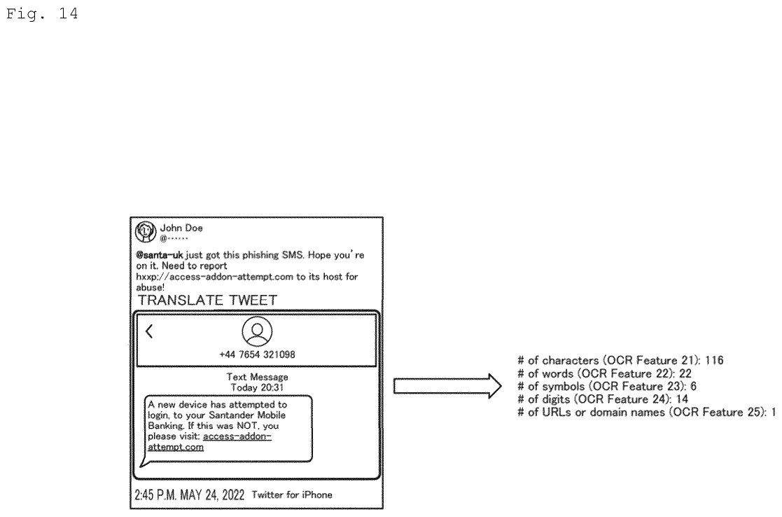

In order to capture features of similar character strings in a Tweet related to a phishing attack, the feature value extraction unit 232 generates OCR Features for each Tweet from character strings extracted by optical character recognition (OCR), for example, as shown in FIG. 14. The OCR Features include, for example, a character string, words, symbols, digits, an URL or a domain name, and the like.

### (5-5) Visual Feature

In order to capture commonality of the appearance of an image included in a Tweet related to a phishing attack report, the feature value extraction unit 232 generates Visual Features for each Tweet from an image associated with the Tweet.

The feature value extraction unit 232 generates a vector of a fixed dimension of an image associated with a Tweet by using an Efficient Net model (see Literature 5) which shows an excellent result in image classification. Thereafter, the feature value extraction unit 232 compresses the dimension of the vector by a Truncated SV (see Literature 6) for converting a sparse vector into a dense vector. Then, the feature value extraction unit 232 sets the compressed vector as a Visual Feature of an image included in the Tweet.
Literature 5: Tan, Mingxing and Le, Quoc., “EfficientNet: Rethinking Model Scaling for Convolutional Neural Networks”, ICML 2019.
Literature 6: “The truncatedsvd as a method for regularization”, BIT Numerical Mathematics.

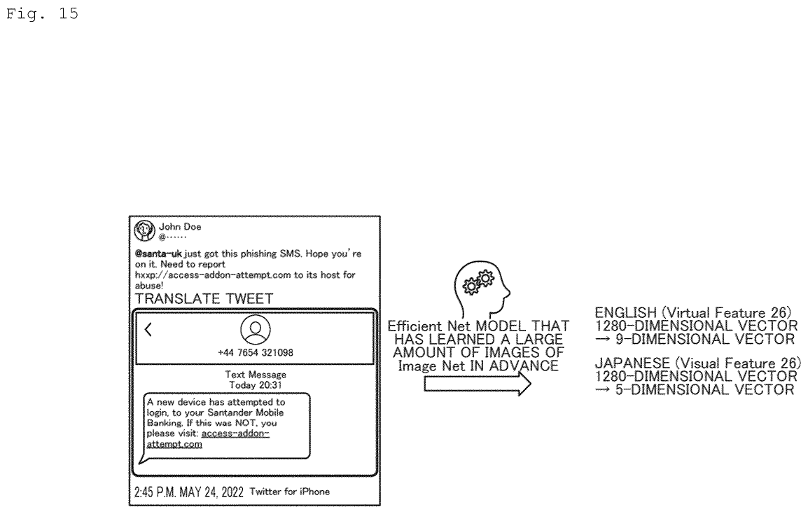

For example, as shown in FIG. 15, the feature value extraction unit 232 converts an image associated with a Tweet into a vector of an intrinsic dimension by using an Efficient Net model obtained by learning a large amount of images of an Image Net in advance. Then, the feature value extraction unit 232 compresses the converted vector to a cumulative contribution rate of 99% in teaching data by Truncated SV.

### (5-6) Context Feature

In order to capture commonality of a context in a Tweet related to a phishing attack report, the feature value extraction unit 232 generates Context Features for each Tweet from a character string in the Tweet.

The feature value extraction unit 232 generates a vector of a fixed dimension from a character string in a Tweet by using, for example, a BERT model which shows an excellent result in sentence classification. Thereafter, the feature value extraction unit 232 compresses the dimension of the vector by Truncated SV. Then, the feature value extraction unit 232 sets the compressed vector as a Context Feature of the Tweet.

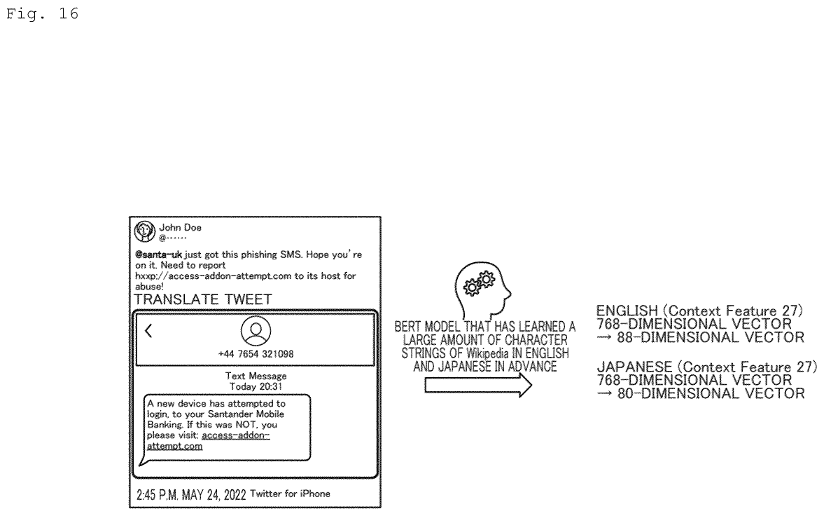

For example, as shown in FIG. 16, the feature value extraction unit 232 converts a character string in a Tweet into a vector of an intrinsic dimension by using a BERT model obtained by learning a large amount of character strings of Wikipedia in English and Japanese in advance. Then, the feature value extraction unit 232 compresses the converted vector to a cumulative contribution rate of 99% in teaching data by Truncated SV.

### (6) Feature Selection

The feature value selection unit 233 selects (important) feature values effective for classification into Tweets on phishing attack reports and the other Tweets from a feature value group generated by the feature value extraction unit 232 in (5).

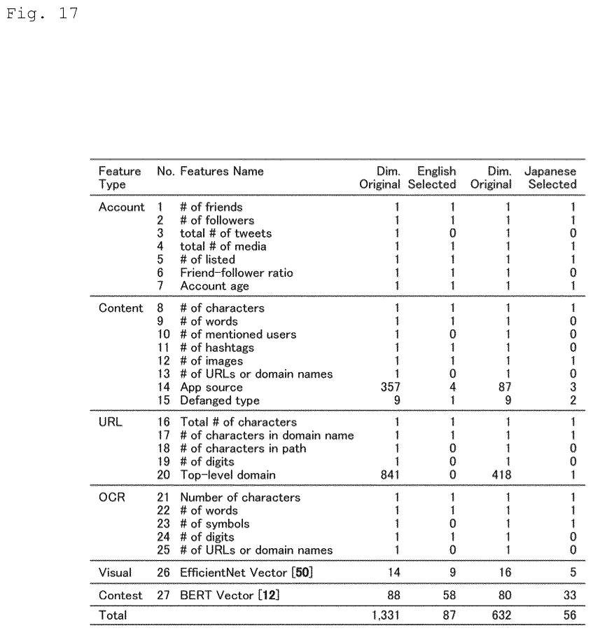

FIG. 17 shows an example of feature values determined to be important feature values in classification as a result of Feature Selection.

Account Feature: Six types of English (six-dimensional), five types of Japanese (five-dimensional)

Content Feature: Six types of English (nine-dimensional), four types of Japanese (seven-dimensional)

URL Feature: Two types of English (two-dimensional), three types of Japanese (three-dimensional)

OCR Feature: Three types of English (three-dimensional), three Types of Japanese (three-dimensional)

Visual Feature: English 9-dimensional, Japanese 5-dimensional Context Feature: English 58-dimensional, Japanese 33-dimensional

In the Context Features shown in FIG. 17, for App source (14), Twitter Web App, Twitter for iphone (registered trademark), and Twitter for Android (registered trademark) are important in both languages, and PhishingPicker is important only in English. In addition, for Defanged type (15), example [.] com is important in both languages, and hxxp is important only in Japanese. Further, among the URL Features shown in FIG. 17, for Top-level domain (20), .xyz is important only in the case of Japanese.

Finally, it is confirmed that feature values of 87-dimensional English and 56-dimensional Japanese are important for classification into Tweets on phishing attack reports and the other Tweets.

### (7) Offline Training

The learning unit 234 learns a classification model (Machine Learning Model) by using the feature values (feature vectors) selected by the feature value selection unit 233 in (6) and teaching data (Ground-Truth Dataset) to which a correct answer label indicating whether it is a phishing attack is attached.

As an algorithm used for learning the classification model, for example, Random Forest, Neural Network, Decision Tree, Support Vector Machine, Logistic Regression, Naive Bayes, Gradient Boosting, Stochastic Gradient Descent, or the like is conceivable. As a result of evaluation of teaching data for these algorithms, it is confirmed that Random Forest is preferably used for the following three reasons.
Random Forest is superior in classification accuracy than any other algorithm.
Random Forest is operated at a stable speed in both learning and estimation (classification) phases.
Random Forest has distributed feature value importances for all six types of features.

### (8) Online Classification

The classification unit 235 classifies whether Tweets collected by the collection device 10 are Tweets (positive) related to a phishing attack report or not (Negative) by using the Machine Learning Model (classification model) learned in (7). Further, the output processing unit 236 outputs a result of the classification.

The classification apparatus 20 may extract Proper Nouns appearing in the Tweets classified as the phishing attack reports, and the collection device 10 may use the Proper Nouns to extract Co-occurrence Keywords.

### Evaluation Result

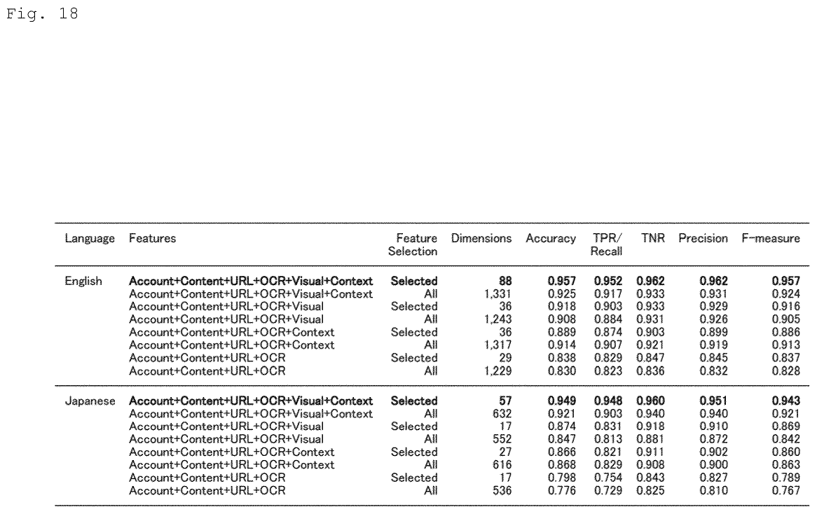

Next, evaluation results of the system according to the present embodiment will be described. For example, it is confirmed that the system can classify whether it is a Tweet on a phishing attack report with accuracy of approximately 95% in both English and Japanese by using feature values selected by the system (see FIG. 18).

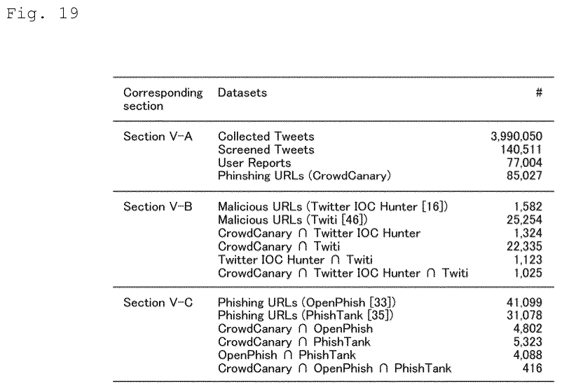

In addition, the system according to the present embodiment could extract 77,004 phishing attacks reports (User Reports) and 85,027 Phishing URLs, as shown in FIG. 19, during an experimental period (Aug. 1, 2021 to Sep. 30, 2021).

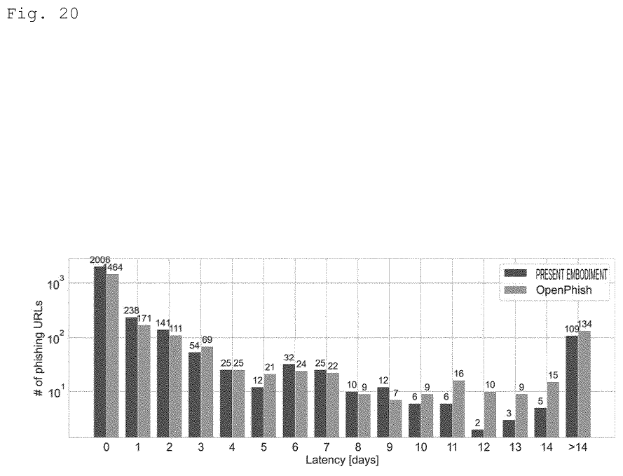

Further, when phishing URLs collected by OpenPhish (see Literature 7) which is an existing data feed were compared with the phishing URLs collected by the system according to the present embodiment (see FIG. 20), the system according to the present embodiment was able to collect 2,686 phishing URLs (55.9% of the total) more rapidly among 4,802 phishing URLs that were common to both.
Literature 7: “OpenPhish-Phishing Intelligence”, https://openphish.com

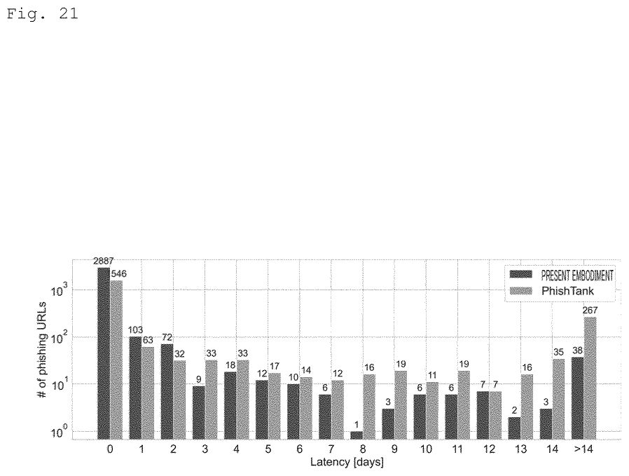

Further, when phishing URLs collected by PhishTank (see Literature 8) which is an existing data feed were compared with the phishing URLs collected by the system according to the present embodiment (see FIG. 21), the system according to the present embodiment was able to collect 3,183 phishing URLs (59.8% of the total) more rapidly among 5,323 phishing URLS that were common to both.
Literature 8: “PhishTank|Join the fight against phishing”, https://www.phishtank.com/.

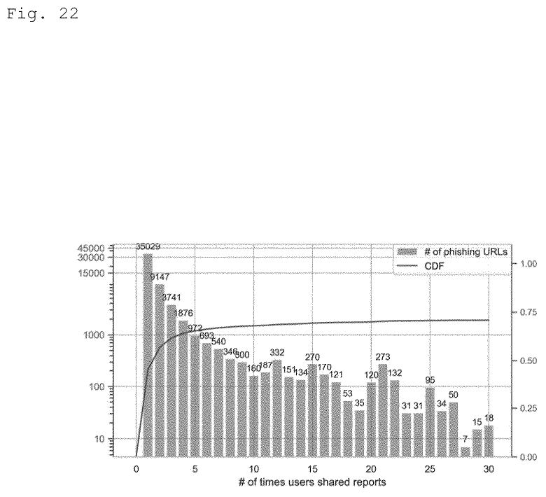

Furthermore, when the number of phishing attacks reported by users and the number of phishing URLS were examined, it was confirmed that phishing attacks reported only once by the users were 49.8% of all phishing URLs (see FIG. 22). In other words, it was confirmed that phishing attack reports from a wide range of users were highly likely to include a highly unique phishing URL. From this, it was confirmed that it was very effective to collect phishing attack reports from a wide range of users as in the system according to the present embodiment.

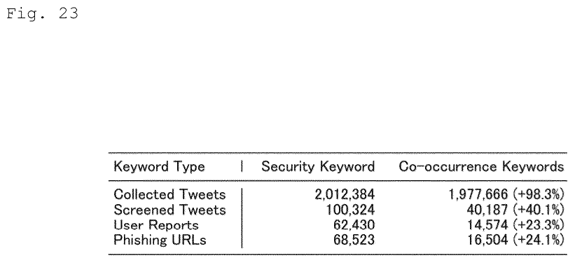

In addition, an effect of using not only fixed keywords (Security Keywords) but also dynamic keywords (Co-occurrence Keywords) was confirmed for collection of Tweets on phishing attack reports (see FIG. 23). As a result, it was confirmed that +23.3% of User Reports (Tweets on phishing attack reports) could be extracted when using not only fixed keywords (Security Keywords) but also dynamic keywords (Co-occurrence Keywords) as compared to when using only the fixed keywords (Security Keywords). Further, it was confirmed that +24.1% of phishing URLs could be extracted when using not only fixed keywords (Security Keywords) but also dynamic keywords (Co-occurrence Keywords).

From this, it is confirmed that collection of Tweets using not only fixed keywords (Security Keywords) but also dynamic keywords (Co-occurrence Keywords) as in the system of the present embodiment is extremely effective for collection of information on phishing attacks.

### [System Configuration, Etc.]

In addition, each component of each unit that has been illustrated is functionally conceptual, and is not necessarily physically configured as illustrated. In other words, the specific forms of dispersion and integration of each apparatus are not limited to those illustrated in the drawings and all of or a part of the apparatus can be functionally or physically distributed or integrated in any unit depending on various loads, usage conditions, or the like. Furthermore, all or any part of each processing function performed in each apparatus can be implemented by a CPU and a program executed by the CPU, or can be implemented as hardware by a wired logic.

In addition, among the processes described in the above-described embodiment, all or some of the processes described as being automatically executed may also be manually executed. Alternatively, all or some of the processes described as being manually executed may also be automatically executed using a known method. In addition, the processing procedure, the control procedure, specific names, information including various types of data and parameters that are shown in the above document and drawings may be arbitrarily changed unless otherwise described.

### [Program]

The system described above can be implemented by installing a program as package software or online software in a desired computer. For example, by executing the above-described program by an information processing device, the information processing device can function as the above-described system. The information processing device referred to here includes a mobile communication terminal such as a smartphone, a mobile phone, or a Personal Handyphone System (PHS), and further includes terminals such as a Personal Digital Assistant (PDA), or the like.

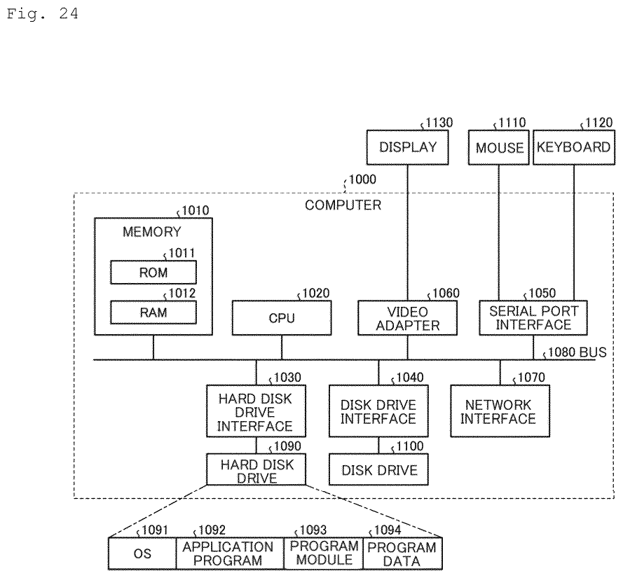

FIG. 24 is a diagram showing an example of a computer that executes a program. A computer 1000 includes, for example, a memory 1010 and a CPU 1020. Further, the computer 1000 includes a hard disk drive interface 1030, a disk drive interface 1040, a serial port interface 1050, a video adapter 1060, and a network interface 1070. These parts are connected to each other by a bus 1080.

The memory 1010 includes a Read Only Memory (ROM) 1011 and a Random Access Memory (RAM) 1012. The ROM 1011 stores, for example, a boot program such as a Basic Input Output System (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. In other words, a program that defines each processing executed by the system described above is implemented as the program module 1093 in which a computer-executable code is described. The program module 1093 is stored in, for example, the hard disk drive 1090. For example, the program module 1093 for executing processing similar to the functional components in the system is stored in the hard disk drive 1090. The hard disk drive 1090 may be replaced with a Solid State Drive (SSD).

Data used in the processing of the above-described embodiment is stored as the program data 1094 in the memory 1010 or the hard disk drive 1090, for example. Then, the CPU 1020 reads the program module 1093 and the program data 1094 stored in the memory 1010 or the hard disk drive 1090 into the RAM 1012 and executes them as necessary.

The program module 1093 and the program data 1094 are not limited to being stored in the hard disk drive 1090, and may be stored in, for example, a detachable storage medium and read by the CPU 1020 via the disk drive 1100 or the like.

Alternatively, the program module 1093 and the program data 1094 may be stored in another computer connected via a network (a Local Area Network (LAN), a Wide Area Network (WAN), or the like). Then, the program module 1093 and the program data 1094 may be read by the CPU 1020 from another computer via the network interface 1070.

### REFERENCE SIGNS LIST

10 Collection device
11, 21 Input/output unit
12, 22 Storage unit
13, 23 Control unit
20 Classification apparatus
131 First collection unit
132 Keyword extraction unit
133 Second collection unit
134 Data collection unit
135 URL/domain name extraction unit
136 Sorting unit
231 Data acquisition unit
232 Feature value extraction unit
233 Feature value selection unit
234 Learning unit
235 Classification unit
236 Output processing unit

1. A classification apparatus comprising:
a memory; and
processing circuitry configured to:
extract feature values of text and an image included in a post related to a security threat of a Social Networking Service (SNS) from the post;
perform learning using the feature values for teaching data to which a correct answer label indicating whether each post is a post related to the security threat is attached to thereby learn a machine learning model for classifying whether an input post is a post related to the security threat;
classify whether an input post is a post related to the security threat by using the learned machine learning model; and
output a result of classification.

2. The classification apparatus according to claim 1, wherein the feature values of the image included in the post include a feature value of the image and a feature value of a character string obtained by optical character recognition of the image.

3. The classification apparatus according to claim 1, wherein the feature values include a feature value of an URL or a domain name extracted from the text or the image of the post.

4. The classification apparatus according to claim 1, wherein the feature value is at least any of a feature value of an account of a poster of the post, a feature value of a content of the post, a feature value of an URL or a domain name extracted from the text or the image of the post, a feature value of a character string obtained by optical recognition of the image included in the post, a feature value of the image included in the post, and a feature value of context of the text included in the post.

5. The classification apparatus according to claim 1, wherein the processing circuitry is further configured to select a feature value effective for classification of whether a post is related to the security threat from among the feature values extracted, and
learn the machine learning model by using the selected feature value.

6. The classification apparatus according to claim 5, wherein the processing circuitry is further configured to
select a feature value effective for classification of whether a post is related to the security threat by Boruta-SHAP.

7. A classification method executed by a classification apparatus, the classification method comprising:
extracting feature values of text and an image included in a post related to a security threat of a Social Networking Service (SNS) from the post;
performing learning using the feature values for teaching data to which a correct answer label indicating whether each post is a post related to the security threat is attached to thereby learn a machine learning model for classifying whether an input post is a post related to the security threat;
classifying whether an input post is a post related to the security threat by using the learned machine learning model; and
outputting a result of classification.

8. A non-transitory computer-readable recording medium storing therein a classification program that causes a computer to execute a process comprising:
extracting feature values of text and an image included in a post related to a security threat of a Social Networking Service (SNS) from the post;
performing learning using the feature values for teaching data to which a correct answer label indicating whether each post is a post related to the security threat is attached to thereby learn a machine learning model for classifying whether an input post is a post related to the security threat;
classifying whether an input post is a post related to the security threat by using the learned machine learning model; and
outputting a result of classification.
